(19) United States
(12) Patent Application Publication
(10) Pub. No.: US 2018/0222384 A1
(43) Pub. Date: Aug. 9, 2018

(54) AUDIO OF EXTERNAL SPEAKERS OF VEHICLES BASED ON IGNITION SWITCH POSITIONS

(71) Applicant: Ford Global Technologies, LLC, Dearborn, MI (US)

(72) Inventor: Aed M. Dudar, Canton, MI (US)

(21) Appl. No.: 15/427,796

(22) Filed: Feb. 8, 2017

(51) Int. Cl. B60Q 5/00; B60W 10/06

(52) U.S. Cl. CPC B60Q 5/001; B60W 10/06; B60L 2270/42; B60W 2710/06; B60W 2510/244

(57) ABSTRACT

Method and apparatus are disclosed for audio of external speakers of vehicles based on ignition switch positions. An example vehicle includes an exterior surface, an external speaker positioned along the exterior surface, an ignition switch, and a speaker controller. The speaker controller is to determine, in response to the ignition switch being in an on position, whether to present simulated engine noise via the external speaker and present, in response to the ignition switch being in an accessory position, media audio via the external speaker.

### TECHNICAL FIELD

The present disclosure generally relates to vehicle speakers and, more specifically, audio of external speakers of vehicles based on ignition switch positions.

### BACKGROUND

Oftentimes, vehicles include one or more speakers within a vehicle to present audio to occupants (e.g., a driver, one or more passengers) positioned in a cabin of the vehicle. The speakers may present media audio (e.g., radio, streamed music, audio books, podcasts, etc.) to the occupants for entertainment purposes as the driver is operating the vehicle. Additionally, the speakers may audibly present directions to the driver and/or present audio from a telephonic conversation of an occupant located in the cabin of the vehicle.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for audio of external speakers of vehicles based on ignition switch positions. An example disclosed vehicle includes an exterior surface, an external speaker positioned along the exterior surface, an ignition switch, and a speaker controller. The speaker controller is to determine, in response to the ignition switch being in an on position, whether to present simulated engine noise via the external speaker and present, in response to the ignition switch being in an accessory position, media audio via the external speaker.

An example disclosed method for presenting audio via external speakers of vehicles includes monitoring a position of an ignition switch of a vehicle. The example disclosed method also includes presenting, via an external speaker positioned along an exterior surface of the vehicle, media audio in response to the ignition switch being in an accessory position and determining, via a processor, whether to present simulated engine noise via the external speaker in response to the ignition switch being in an on position.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle including an external speaker in accordance with the teachings herein.

FIG. 2 illustrates an ignition switch of the vehicle of FIG. 1.

FIG. 3 is a block diagram of electronic components of the vehicle of FIG. 1.

FIG. 4 is a flowchart of an example of presenting media audio and simulated engine noise via the external speaker of the vehicle of FIG. 1 in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Vehicles typically include one or more speakers within a cabin of the vehicle to present audio to occupants (e.g., a driver, one or more passengers) located inside the cabin. The speakers may present media audio (e.g., radio, streamed music, audio books, podcasts, etc.) to the occupants for entertainment purposes as the driver is operating the vehicle. Additionally, the speakers may audibly present directions to the driver and/or present audio from a telephonic conversation of an occupant located in the cabin of the vehicle.

In some instances, a user of a vehicle may desire to listen to media audio when the user is located outside of the cabin and nearby the vehicle. For example, the user may desire to listen to media audio when picnicking, tailgating, gardening, etc. near the vehicle. In some such instances, users utilize one or more speakers located within the cabin and open one or more windows and/or doors of the vehicle to enable the media audio to be emitted to areas surrounding the vehicle, thereby potentially exposing the cabin of the vehicle to inclement weather conditions. In other such instances, users utilize auxiliary portable speakers that the user electrically connects to the vehicle and positions outside of the cabin of the vehicle, thereby potentially requiring additional equipment and set-up time and/or exposing the portable speakers to inclement weather conditions.

Example methods, apparatus and computer readable media disclosed herein include an external speaker positioned along an exterior surface of a vehicle (e.g., an electric vehicle, a hybrid-electric vehicle, etc.) that is to emit media audio when an ignition switch of the vehicle is in an accessory position and is to emit simulated engine noise when the ignition switch is in an on position. For example, the external speakers disclosed herein emit the media audio when the vehicle is parked to entertain and/or inform people located nearby the vehicle (e.g., while picnicking, tailgating, gardening, etc.) and emit the simulated engine noise when the vehicle is being propelled quietly by a electric engine to audibly alert nearby pedestrians to the vehicle.

Example vehicles (e.g., electric vehicles, hybrid electric vehicles) disclosed herein include an exterior surface, an external speaker positioned along the exterior surface, an ignition switch, and a speaker controller. As used herein, a “external speaker” refers to a speaker of a vehicle that is positioned and/or oriented to emit sound outside of and away from a cabin of the vehicle. As used herein, an “internal speaker” refers to a speaker of a vehicle that is positioned and/or oriented to emit sound within a cabin of the vehicle. As used herein, an “ignition switch” refers to a switch of a vehicle that activates an engine and/or electrical systems of the vehicle. Example ignition switches include rotary switches and/or pushbuttons. In some examples, a key is inserted into a slot of the switch to enable the switch to actuate from one position to another.

When the ignition switch is in an accessory position, the speaker controller is to present media audio via the external speaker. For example, the external speaker is positioned along the exterior surface to enable the media audio to be presented outside of the vehicle without opening a door and/or a window of the vehicle. As used herein, an “accessory position” refers to a position of an ignition switch that activates electronic accessories (e.g., power windows, media units, displays, speakers, etc.) without activating an engine of the vehicle. As used herein, “media audio” refers to audio that provides listeners with information. Example media audio includes audible music, discussions, stories, messages, warnings, etc.

When the ignition switch is in an on position, the speaker controller determines whether to present simulated engine noise via the external speaker. As used herein, an “on position” refers to a position in which an ignition switch when an engine of the vehicle is activated. As used herein, “simulated engine noise” refers to audio emitted by an external speaker of an electric vehicle and/or an hybrid-electric vehicle while powered via an electric motor that emulates noise emitted by an internal combustion engine. As used herein, an “electric vehicle” includes an electric motor for propulsion of the vehicle. As used herein, a “hybrid-electric vehicle” and a “hybrid vehicle” refers to a vehicle that includes an electric motor and another power source, such as an internal combustion engine, for propulsion of the vehicle.

The speaker controller presents the simulated engine noise via the external speaker to alert nearby pedestrians of the electric and/or hybrid-electric vehicle that is operating. For example, the noise generated by internal combustion engines oftentimes alert nearby pedestrians of approaching and/or otherwise nearby vehicles. Some electric engines of electric and/or hybrid-electric vehicles generate reduced noise levels when traveling at reduced speeds (e.g., less than or equal to 18 miles per hour) that may potentially be difficult for pedestrians to hear. Because nearby pedestrians potentially may not be audibly alerted to approaching electric and/or hybrid-electric vehicles, some governmental regulations stipulate that electric and/or hybrid-electric vehicles generated simulated engine noise under certain conditions. For example, to alert nearby pedestrians when the electric motor is activated, the speaker controller of the vehicle presents the simulated engine noise via the external speaker in response to the vehicle being stationary, travelling in reverse, and/or travelling forward at a speed less than a predetermined threshold speed (e.g., 18 miles per hour). The vehicle may include a vehicle speed sensor to detect the speed of the vehicle and/or a transmission position sensor to detect a position of a gear stick to determine whether the vehicle is stationary, travelling in reverse, and/or travelling forward.

In some examples, the media audio to be presented via the external speaker is selected and/or received via an input device (e.g., a control knob, a touch screen, etc.) of an infotainment head unit of the vehicle, a mobile device communicatively coupled to a communication module of a vehicle, another vehicle communicatively coupled to the communication module via vehicle-to-vehicle communication, etc. For example, when a mobile device is communicatively coupled to the communication module of the vehicle, the speaker controller may present, via the external speaker, a message (e.g., a text, a post, a voice message, etc.) that is received via the mobile device.

The example vehicles also may include a battery. For example, current is drawn from the battery to power electronic accessories when the ignition switch is in the accessory position. If too much current is drawn, the battery is unable to power the engine of the vehicle. To deter the battery of the vehicle from being discharged, the vehicle includes a battery sensor to detect a charge level of the battery. In some examples, the vehicle also includes a solar panel that recharges the battery when the speaker controller determines that the charge level is less than a predetermined value. Additionally or alternatively, the speaker controller presents a warning via the external speaker and/or sends a signal to autonomously start the engine when the speaker controller determines that the charge level is below the predetermined value.

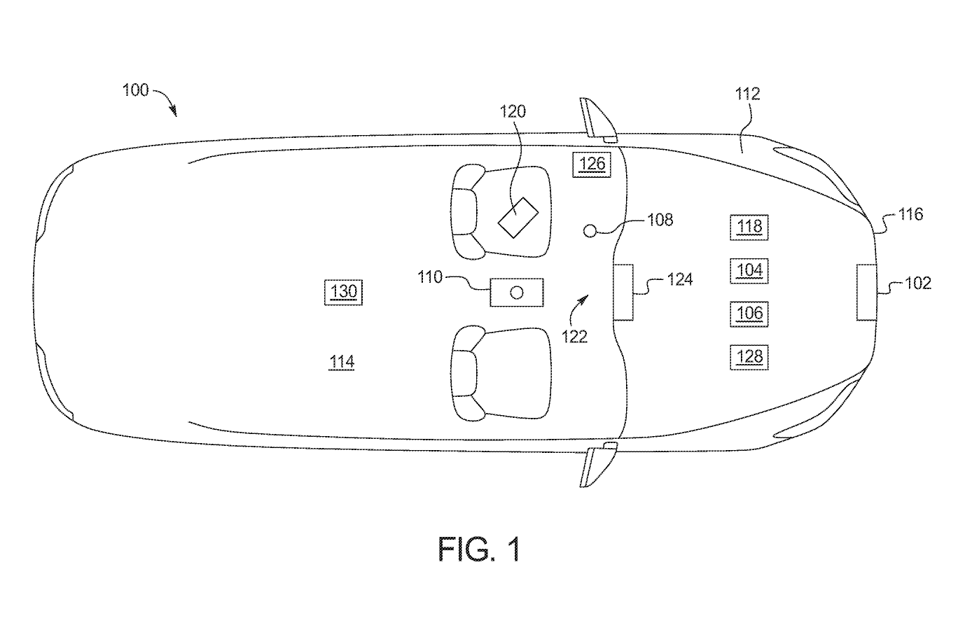

Turning to the figures, FIG. 1 illustrates an example vehicle 100 including an external speaker 102 in accordance with the teachings herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input). In the illustrated example, the vehicle 100 is an electric and/or a hybrid-electric vehicle that includes the external speaker 102, an engine 104, a battery 106, an ignition switch 108, and a gear stick 110.

The external speaker 102 is located on an exterior surface 112 of the vehicle 100 to emit sound outside of and in a direction away from a cabin 114 of the vehicle 100. For example, the external speaker 102 presents audio (e.g., media audio, simulated engine noise, etc.) to people located outside of the cabin 114 and nearby the vehicle 100 without opening a door and/or a window of the vehicle 100. In the illustrated example, the external speaker 102 is located along a front side 116 of the vehicle 100. Additionally or alternatively, the vehicle 100 may include an external speaker along a back side, a left side, and/or a right side of the exterior surface 112 of the vehicle 100. The external speaker 102 is structured and positioned along the exterior surface 112 to deter and/or prevent inclement weather conditions from damaging the external speaker 102.

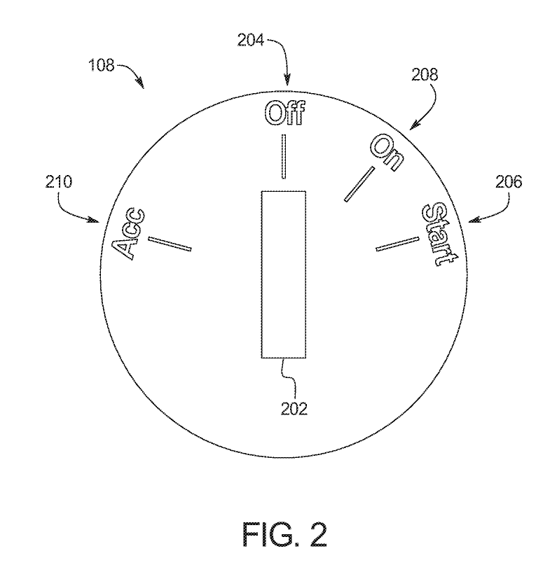

In the illustrated example, the engine 104 includes an electric motor that electrically propels the vehicle 100. The battery 106 provides power to activate the engine 104 and/or electronic accessories (e.g., the external speaker 102, etc.) of the vehicle 100. The ignition switch 108 is utilized by a driver and/or another user of the vehicle 100 to operate the engine 104, the battery 106, and/or the electronic accessories of the vehicle 100. For example, the ignition switch 108 includes an on position (e.g., an on position 208 of FIG. 2) during which the engine 104 and the electronic accessories are activated and/or an accessory position (e.g., an accessory position 210 of FIG. 2) during which the electronic accessories are activated without the engine 104 being activated. Further, the gear stick 110 is utilized to shift between gears (e.g., neutral, reverse, first gear, second gear, etc.) and/or modes (e.g., park, reverse, neutral, drive) of a transmission of the vehicle 100.

The vehicle 100 also includes a communication module 118. In the illustrated example, the communication module 118 includes wired or wireless network interfaces to enable communication with external networks. The communication module 118 also includes hardware (e.g., processors, memory, storage, antenna, etc.) and software to control the wired or wireless network interfaces. In the illustrated example, the communication module 118 includes one or more communication controllers for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m), Near Field Communication (NFC), local area wireless network (including IEEE 802.11 a/b/g/n/ac or others), dedicated short range communication (DSRC), and Wireless Gigabit (IEEE 802.11ad), etc.). In some examples, the communication module 118 includes a wired or wireless interface (e.g., an auxiliary port, a Universal Serial Bus (USB) port, a Bluetooth® wireless node, etc.) to communicatively couple with a mobile device 120 (e.g., a smart phone, a wearable, a smart watch, a tablet, etc.). In such examples, the vehicle 100 may communicate with the external network via the mobile device 120, for example, to receive a selection of media audio and/or a message from the mobile device 120 that is to be presented via the external speaker 102 of the vehicle 100. The external network(s) may be a public network, such as the Internet; a private network, such as an intranet; or combinations thereof, and may utilize a variety of networking protocols now available or later developed including, but not limited to, TCP/IP-based networking protocols. Further, in some examples, the communication module 118 includes an interface for wireless communication with communication modules of other nearby vehicles via vehicle-to-vehicle communication (e.g., to receive a signal for media audio from another vehicle).

Additionally, the vehicle 100 of the illustrated example includes an infotainment head unit 122 that provides an interface between the vehicle 100 and a user. The infotainment head unit 122 includes digital and/or analog interfaces (e.g., input devices and output devices) to receive input (e.g., selection of media audio) from and display information for the user(s). The input devices include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a heads-up display, a center console display (e.g., a liquid crystal display (LCD), an organic light emitting diode (OLED) display, a flat panel display, a solid state display, etc.), and/or speakers. In the illustrated example, the infotainment head unit 122 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). In the illustrated example, the infotainment head unit 122 includes a display 124 to present information to one or more occupants of the vehicle 100. In some examples, the display 124 is a touch screen that haptically receives a selection of media audio from one or more occupants of the vehicle 100. Further, the infotainment head unit 122 includes an internal speaker 126 that is positioned within the cabin 114 of the vehicle 100 to present audio (e.g., media, instructions, messages, telephonic conversations, etc.) to occupants in the cabin 114 of the vehicle 100.

The vehicle 100 of the illustrated example also includes a speaker controller 128 that determines which audio to present and when via the external speaker 102 of the vehicle 100. For example, the speaker controller 128 monitors a position of the ignition switch to determine which audio to present via the external speaker 102. In response to the ignition switch 108 being in an accessory position (e.g., the accessory position 210 of FIG. 2), the speaker controller 128 presents media audio via the external speaker 102. In response to the ignition switch 108 being in an on position (e.g., the on position 208 of FIG. 2), the speaker controller 128 determines whether to present simulated engine noise via the external speaker 102. For example, when the ignition switch 108 is in the on position, the speaker controller determines to present the simulated engine noise via the external speaker 102 in response to detecting that the vehicle 100 is stationary, travelling in reverse, and/or travelling forward at a speed less than a predetermined threshold speed (e.g., 18 miles per hour).

Further, the speaker controller 128 monitors a charge level of the battery 106 over time to deter and/or prevent the battery 106 from being drained or discharged when the ignition switch 108 is in the accessory position and the external speaker 102 is presenting media audio. For example, in response to the speaker controller 128 determining that the charge level of the battery 106 is less than a predetermined level, a solar panel 130 of the vehicle 100 recharges the battery 106, the speaker controller 128 presents a warning via the external speaker 102, and/or the speaker controller 128 sends a signal to autonomously start the engine.

FIG. 2 illustrates the ignition switch 108 of the vehicle 100. The ignition switch 108 includes a slot 202 to receive a key of the vehicle 100. As illustrated in FIG. 2, the ignition switch 108 is in an off position 204. The engine 104 and the electronic accessories (e.g., the external speaker 102, the display 124, the internal speaker 126) of the vehicle 100 are inactivate when the ignition switch 108 is in the off position 204. To activate the engine 104, a user (e.g., a driver) inserts the key into the slot 202 of the ignition switch 108 and turns and/or otherwise actuates the ignition switch 108 to a start position 206. At the start position 206, the engine 104 draws charge from the battery 106 until the engine 104 is activated. Upon activating the engine 104, the ignition switch 108 turns and/or otherwise actuates to an on position 208 at which power is supplied to the engine 104 and the electronic accessories by an alternator of the vehicle 100. To deactivate the engine 104, the user turns and/or otherwise actuates the ignition switch 108 back to the off position 204. Further, to activate the electronic accessories (e.g., the external speaker 102, the display 124, the internal speaker 126) of the vehicle 100 without activating the engine 104, the user may insert the key into the slot 202 and turn the ignition switch 108 to the accessory position 210. When the ignition switch 108 is at the accessory position 210, the electronic accessories draw current from the battery 106.

In the illustrated example, the ignition switch 108 is a rotary switch that rotates between the off position 204, the start position 206, the on position 208 and the accessory position 210. In other examples, the ignition switch may be a pushbutton. In some such examples, the pushbutton is pushed once to be in the on position 208 and is pushed twice in succession to be in the accessory position 210.

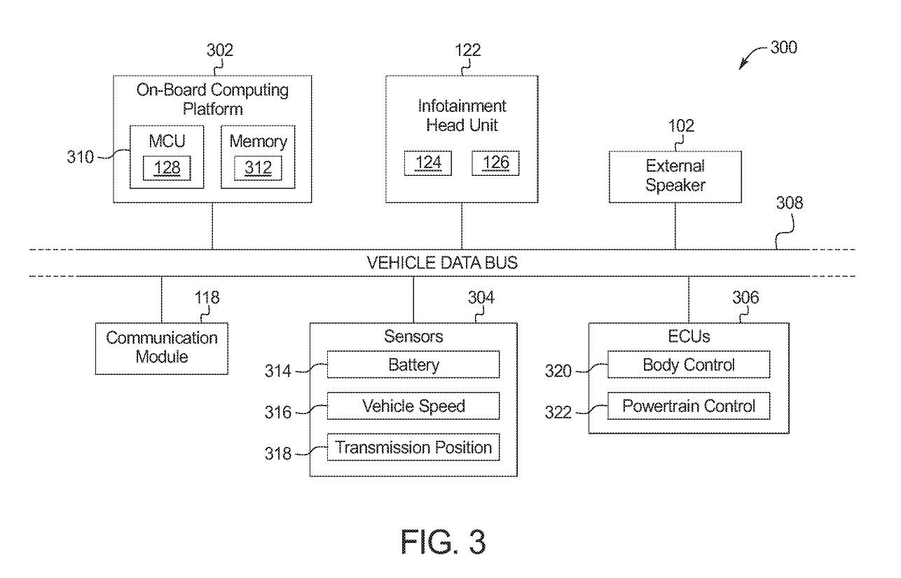

FIG. 3 is a block diagram of electronic components 300 of the vehicle 100. In the illustrated example, the electronic components 300 include an on-board computing platform 302, the infotainment head unit 122, the communication module 118, sensors 304, an electronic control unit 306, and a vehicle data bus 308.

The on-board computing platform 302 includes a microcontroller unit, controller or processor 310 and memory 312. In some examples, the processor 310 of the on-board computing platform 302 is structured to include speaker controller 128. Alternatively, in some examples, the speaker controller 128 is incorporated into another electronic control unit (ECU) with its own processor 310 and memory 312. The processor 310 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 312 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 312 includes multiple kinds of memory, particularly volatile memory and non-volatile memory.

The memory 312 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 312, the computer readable medium, and/or within the processor 310 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The sensors 304 are arranged in and around the vehicle 100 to monitor properties of the vehicle 100 and/or an environment in which the vehicle 100 is located. One or more of the sensors 304 may be mounted to measure properties around an exterior of the vehicle 100. Additionally or alternatively, one or more of the sensors 304 may be mounted inside a cabin of the vehicle 100 or in a body of the vehicle 100 (e.g., an engine compartment, wheel wells, etc.) to measure properties in an interior of the vehicle 100. For example, the sensors 304 include accelerometers, odometers, tachometers, pitch and yaw sensors, wheel speed sensors, microphones, tire pressure sensors, biometric sensors and/or sensors of any other suitable type. In the illustrated example, the sensors 304 include a battery sensor 314, a vehicle speed sensor 316, and a transmission position sensor 318. For example, the battery sensor 314 detects a charge level of the battery 106, the vehicle speed sensor 316 detects a speed at which the vehicle 100 travels (e.g., forward), and the transmission position sensor 318 detects a position at which the gear stick 110 is positioned (e.g., at park, in reverse, in forward, etc.) to determine whether the vehicle 100 is stationary, travelling in reverse, or travelling forward.

The ECUs 306 monitor and control the subsystems of the vehicle 100. For example, the ECUs 306 are discrete sets of electronics that include their own circuit(s) (e.g., integrated circuits, microprocessors, memory, storage, etc.) and firmware, sensors, actuators, and/or mounting hardware. The ECUs 306 communicate and exchange information via a vehicle data bus (e.g., the vehicle data bus 308). Additionally, the ECUs 306 may communicate properties (e.g., status of the ECUs 306, sensor readings, control state, error and diagnostic codes, etc.) to and/or receive requests from each other. For example, the vehicle 100 may have seventy or more of the ECUs 306 that are positioned in various locations around the vehicle 100 and are communicatively coupled by the vehicle data bus 308. In the illustrated example, the ECUs 306 include a body control module 320 and a powertrain control module 322. The body control module 320 controls one or more subsystems throughout the vehicle 100, such as power windows, power locks, an immobilizer system, power mirrors, etc. For example, the body control module 320 includes circuits that drive one or more of relays (e.g., to control wiper fluid, etc.), brushed direct current (DC) motors (e.g., to control power seats, power locks, power windows, wipers, etc.), stepper motors, LEDs, etc. The powertrain control module 322 controls operation of a transmission and the engine 104 of the vehicle 100.

The vehicle data bus 308 communicatively couples the communication module 118, the infotainment head unit 122, the on-board computing platform 302, the sensors 304, and the ECUs 306. In some examples, the vehicle data bus 308 includes one or more data buses. The vehicle data bus 308 may be implemented in accordance with a controller area network (CAN) bus protocol as defined by International Standards Organization (ISO) 12498-1, a Media Oriented Systems Transport (MOST) bus protocol, a CAN flexible data (CAN-FD) bus protocol (ISO 12498-7) and/a K-line bus protocol (ISO 9141 and ISO 14230-1), and/or an Ethernet™ bus protocol IEEE 802.3 (2002 onwards), etc.

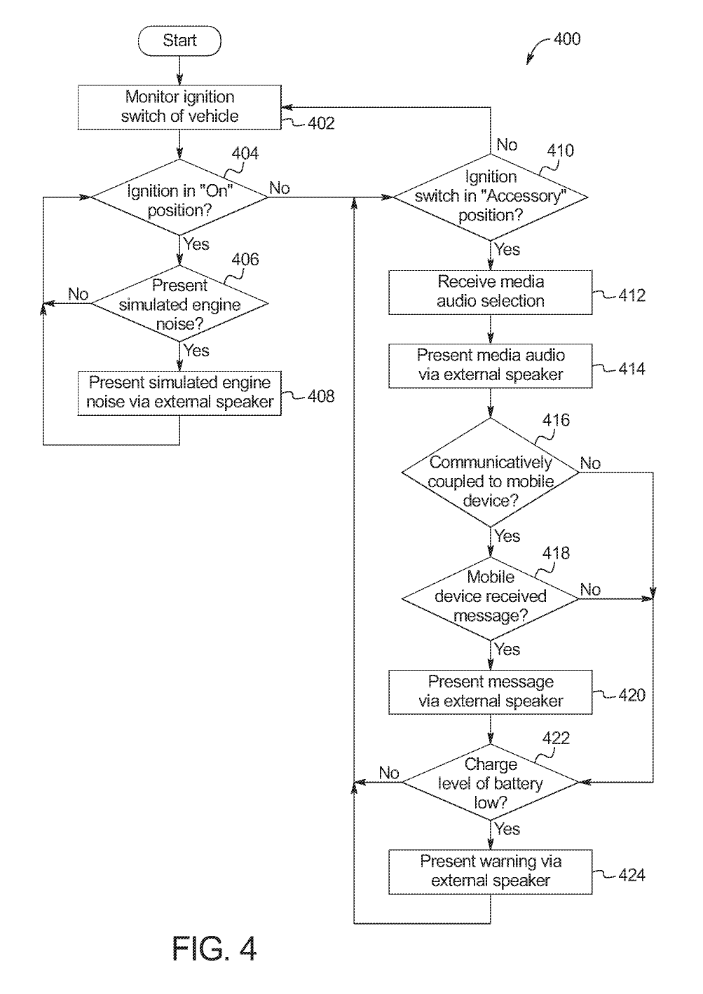

FIG. 4 is a flowchart of an example method 400 to present media audio and simulated engine noise via an external speaker of a vehicle. The flowchart of FIG. 4 is representative of machine readable instructions that are stored in memory (such as the memory 312 of FIG. 3) and include one or more programs which, when executed by a processor (such as the processor 310 of FIG. 3), cause the vehicle 100 to implement the example speaker controller 128 of FIGS. 1 and 3. While the example program is described with reference to the flowchart illustrated in FIG. 4, many other methods of implementing the example speaker controller 128 may alternatively be used. For example, the order of execution of the blocks may be rearranged, changed, eliminated, and/or combined to perform the method 400. Further, because the method 400 is disclosed in connection with the components of FIGS. 1-3, some functions of those components will not be described in detail below.

Initially, at block 402, the speaker controller 128 monitors the ignition switch 108 of the vehicle 100 to identify a position of the ignition switch 108. Further, at block 404, the speaker controller 128 determines whether the ignition switch 108 is in the on position 208.

In response to the speaker controller 128 determining that the ignition switch 108 is in the on position 208, the method 400 proceeds to block 406 at which the speaker controller 128 determines whether to present simulated engine noise via the external speaker 102. For example, the speaker controller 128 is to present the simulated engine noise when the ignition switch 108 is in the on position 208 and the vehicle 100 is stationary, travelling in reverse, and/or travelling forward at a speed less than a predetermined threshold speed (e.g., 18 miles per hour). In response to determining that the simulated engine noise is to be presented, the speaker controller 128 presents the simulated engine noise via the external speaker 102 of the vehicle 100 (block 408). Upon determining at block 406 that the simulated engine noise is not to be presented or presenting the simulated engine noise at block 408, the method 400 returns to block 404.

In response to the speaker controller 128 determining at block 404 that the ignition switch 108 is not in the on position 208, the method 400 proceeds to block 410 at which the speaker controller 128 determines whether the ignition switch 108 is in the accessory position 210. In response to the speaker controller 128 determining that the ignition switch 108 is not in the accessory position 210, the method 400 returns to block 402. In response to the speaker controller 128 determining that the ignition switch 108 is in the accessory position 210, the method 400 proceeds to block 412 at which the speaker controller 128 receives a selection of media audio to be presented. For example, the speaker controller 128 receives the selection of media audio via an input device of the infotainment head unit 122, via the mobile device 120 communicatively coupled to the communication module 118 of the vehicle 100, and/or via vehicle-to-vehicle communication from another vehicle communicatively coupled to the communication module 118. At block 414, the speaker controller 128 present the media audio via the external speaker 102.

Further, at block 416, the speaker controller 128 determines whether the communication module 118 of the vehicle 100 is communicatively coupled to the mobile device 120. In response to the communication module 118 and the mobile device 120 being communicatively coupled, the method 400 proceeds to block 418 at which the speaker controller 128 determines whether the mobile device 120 has received a message (e.g., a text, a post, a voice message, etc.). In response to the determining that the mobile device 120 has received a message, the method 400 proceeds to block 420 at which the speaker controller 128 presents the message via the external speaker 102. For example, if the external speaker 102 is emitting audio from a radio signal when the mobile device 120 receives the message, the speaker controller 128 temporarily turns off the radio to enable the external speaker 102 to present the received message. After the message is presented, the speaker controller 128 again causes the external speaker 102 to emit audio from the radio signal.

Upon determining at block 416 that the communication module 118 and the mobile device 120 are not communicatively coupled, determining at block 418 that the mobile device 120 has not received a message, or presenting the message at block 420, the method 400 proceeds to block 422 at which the speaker controller 128 detects whether the charge level of the battery 106 is low. For example, the speaker controller 128 determines that the charge level of the battery 106 is low when the charge level is less than a predetermined value. In response to the speaker controller 128 determining that the charge level is low, the method 400 proceeds to block 424 at which the speaker controller 128 presents a warning via the external speaker 102 indicating that he charge level of the battery 106 is low. Additionally or alternatively, the solar panel 130 may recharge the battery 106 and/or the speaker controller 128 may send a signal to autonomously start the engine 104 upon the speaker controller 128 determining t that the charge level is low.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
an exterior surface;
an external speaker positioned along the exterior surface;
an ignition switch; and
a speaker controller to:
determine, in response to the ignition switch being in an on position, whether to present simulated engine noise via the external speaker; and
present, in response to the ignition switch being in an accessory position, media audio via the external speaker.

2. The vehicle of claim 1, wherein the speaker controller presents the simulated engine noise via the external speaker in response to at least one of the vehicle being stationary, travelling in reverse, and travelling forward at a speed less than a predetermined threshold speed.

3. The vehicle of claim 2, further including a transmission position sensor to detect a position of a gear stick to determine whether the vehicle is stationary, travelling in reverse, or travelling forward.

4. The vehicle of claim 2, further including a vehicle speed sensor to detect the speed of the vehicle.

5. The vehicle of claim 1, further including an input device of an infotainment head unit to receive a selection of the media audio.

6. The vehicle of claim 1, further including a communication module for wireless communication.

7. The vehicle of claim 6, wherein the communication module receives a signal for the media audio from another vehicle via vehicle-to-vehicle communication.

8. The vehicle of claim 6, wherein the communication module receives a selection of the media audio from a mobile device communicatively coupled to the communication module.

9. The vehicle of claim 8, wherein in response to the mobile device receiving a message, the communication module receives the message from the mobile device and the speaker controller presents the message via the external speaker.

10. The vehicle of claim 1, further including a battery and a battery sensor to detect a charge level of the battery.

11. The vehicle of claim 10, further including a solar panel to recharge the battery in response to the speaker controller determining the charge level is less than a predetermined value.

12. The vehicle of claim 10, wherein the speaker controller presents a warning via the external speaker in response to the speaker controller determining the charge level is less than a predetermined value.

13. The vehicle of claim 10, wherein the speaker controller sends a signal to autonomously start an engine in response to the speaker controller determining the charge level is less than a predetermined value.

14. The vehicle of claim 1, wherein the external speaker is positioned along the exterior surface to enable the media audio to be presented outside of the vehicle without opening a door or a window.

15. A method for presenting audio via external speakers of vehicles, the method comprising:
monitoring a position of an ignition switch of a vehicle;
presenting, via an external speaker positioned along an exterior surface of the vehicle, media audio in response to the ignition switch being in an accessory position; and
determining, via a processor, whether to present simulated engine noise via the external speaker in response to the ignition switch being in an on position.

16. The method of claim 15, further including presenting the simulated engine noise when the ignition switch is in the on position and the vehicle is at least one of being stationary, travelling in reverse, and travelling forward at a speed less than a predetermined threshold speed.

17. The method of claim 16, further including
detecting, via a transmission position sensor, a position of a gear stick to determine whether the vehicle is stationary, travelling in reverse, or travelling forward; and
detecting, via a vehicle speed sensor, the speed at which the vehicle is travelling forward.

18. The method of claim 15, further including receiving a signal of the media audio to be presented via the external speaker from another vehicle via vehicle-to-vehicle communication.

19. The method of claim 15, further including receiving a signal of at least one of the media audio and a message to be presented via the external speaker from a mobile device that is wirelessly coupled to a communication module of the vehicle.

20. The method of claim 15, further including:
detecting, via a battery sensor, a charge level of a battery of the vehicle; and
in response to determining the charge level is less than a predetermined value, at least one of:
recharging the battery via a solar panel of the vehicle;
presenting a warning via the external speaker; and
sending a signal to autonomously start an engine of the vehicle.
